(19) United States
(12) Patent Application Publication
(10) Pub. No.: US 2016/0140990 A1
(43) Pub. Date: May 19, 2016

(54) MAGNETIC DISK DEVICE AND METHOD OF CONTROLLING MAGNETIC DISK DEVICE

(71) Applicant: Kabushiki Kaisha Toshiba, Tokyo (JP)

(72) Inventor: Yusuke Kubota, Kawasaki Kanagawa (JP)

(21) Appl. No.: 14/656,538

(22) Filed: Mar. 12, 2015

Related U.S. Application Data
(60) Provisional application No. 62/079,874, filed on Nov. 14, 2014.

(51) Int. Cl. G11B 5/55

(52) U.S. Cl. CPC G11B 5/5547

(57) ABSTRACT

According to one embodiment, a method of controlling a magnetic disk device, includes acquiring a retry rate indicating a ratio of the number of retries to the number of seeks for a seek distance selected in a seek operation related to a read operation and a write operation, and adjusting a predicted seek time for the selected seek distance based on the acquired retry rate.

### CROSS-REFERENCE TO RELATED APPLICATIONS

This application claims the benefit of U.S. Provisional Application No. 62/079,874, filed Nov. 14, 2014, the entire contents of which are incorporated herein by reference.

### FIELD

Embodiments described herein relate generally to a magnetic disk device and a method of controlling the magnetic disk device.

### BACKGROUND

A magnetic disk device (hard disk drive [HOD]) comprises a table prepared in advance in which the relationship between a seek distance and a predicted seek time is set, and the table is used for command rearrangement, namely, a reordering operation to improve random access performance. When a seek operation is to be performed, a predicted seek time is determined with reference to the table.

However, the seek characteristics are not always constant, but vary because of individual differences between devices and an environment. In a conventional magnetic disk device, the relationship between a seek distance and a predicted seek time is fixed, and thus a seek operation is not always performed at optimal predicted seek time.

Therefore, there have been demands for a magnetic disk device and a method of controlling the magnetic disk device which make it possible to improve seek operations.

### BRIEF DESCRIPTION OF THE DRAWINGS

FIG. 1 is a block diagram showing a structure of a magnetic disk device of an embodiment.

FIG. 2 is a functional block diagram showing functions of a controller of an embodiment.

FIG. 3 is a diagram showing an example of relationship between an amount of change in a predicted seek time and random access performance.

FIG. 4 is a diagram showing an example of relationship between the amount of change in a predicted seek time and retry rate.

FIG. 5 is a schematic view of a table showing relationship between a seek distance and a predicted seek time and the like of the embodiment.

FIG. 6 is a flowchart showing an operation of a seek counter and a retry counter of the embodiment.

FIG. 7 is a flowchart showing a method of adjusting a predicted seek time of the embodiment.

### DETAILED DESCRIPTION

In general, according to one embodiment, a method of controlling a magnetic disk device, includes:

acquiring a retry rate indicating a ratio of the number of retries to the number of seeks for a seek distance selected in a seek operation related to a read operation and a write operation; and adjusting a predicted seek time for the selected seek distance based on the acquired retry rate.

Embodiments will be described hereinafter with reference to accompanying drawings.

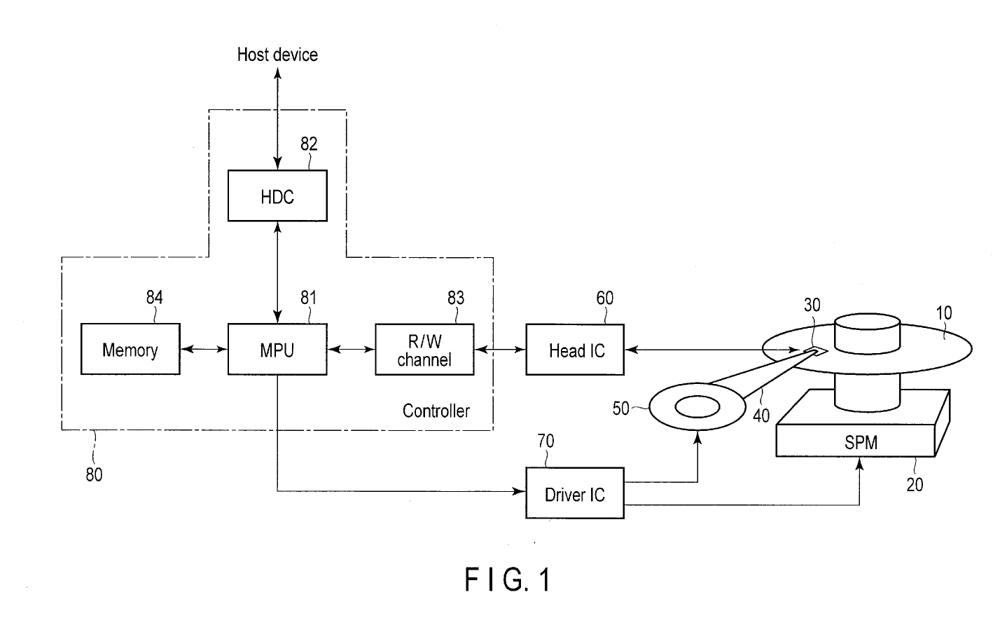

FIG. 1 is a block diagram showing a structure of a magnetic disk device (hard disk drive [HDD] device) of an embodiment.

A magnetic disk (hard disk) 10 is configured to be rotated by a spindle motor (SPM) 20 at a specific speed. In vicinity of the magnetic disk 10, a magnetic head 30 configured to perform a read operation and a write operation on the magnetic disk 10 is provided. The magnetic head 30 connects to an actuator 40 and is configured to be moved to a desired position by the actuator 40. The actuator 40 is driven by a voice coil motor (VCM) 50.

Control of the write operation and the read operation of the magnetic head 30 is performed by a head IC 60. Further, the SPM 20 and the VCM 50 are driven by a driver IC 70.

To the head IC 60 and to the driver IC 70, a controller 80 is connected. The controller 80 comprises a microprocessor unit (MPU) 81, a hard disk controller (HDC) 82, an R/W channel 83 and a memory 84.

The MPU 81 functions as a main processor of the magnetic disk device. The MPU 81 is connected to a host device (for example, a personal computer) via the HDC 82. Further, the MPU 81 is connected to the head IC 60 via the R/W channel 83, and based on the control of the MPU 81, the magnetic head 30 is controlled via the R/W channel 83 and the head IC 60. Still further, the MPU 81 is connected to the driver IC 70, and based on the control of the MPU 81, the SPM 20 and the VCM 50 are controlled via the driver IC 70. Still further, to the MPU 81, the memory 84 comprising a ROM and a RAM is connected. In the memory 84, various kinds of data for controlling the read operation and the write operation on the magnetic disk 10 are stored.

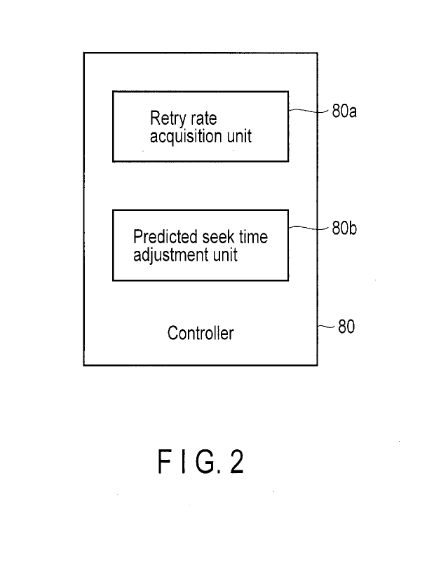

FIG. 2 is a functional block diagram showing functions of the controller 80 of the present embodiment. In the present embodiment, the controller 80 comprises a function of controlling a predicted seek time in the read operation and the write operation. More specifically, the controller 80 comprises a retry rate acquisition unit 80a and a predicted seek time adjustment unit 80b. The retry rate acquisition unit 80a is configured to acquire a retry rate indicating a ratio of the number of retries to the number of seeks for a selected seek distance in a seek operation related to the read operation and the write operation. The predicted seek time adjustment unit 80b is configured to adjust a predicted seek time for the selected seek distance based on the retry rate acquired by the retry rate acquisition unit 80a. Now, the controller 80 will be described in detail.

Generally, in a magnetic disk device, command rearrangement based on a predicted seek time, namely, reordering is executed. In a seek operation selected by the reordering, if a predicted seek time is excessively short as compared to an actual seek time, the probability of performing a retry becomes high. Consequently, time spent on retries increases, and thus random access performance will deteriorate. Also, if a predicted seek time is excessively long as compared to an actual seek time, rotational latency increases although the probability of performing the retry becomes low, and thus random access performance will deteriorate in this case as well. Therefore, an effective way of enhancing the random access performance exhibited when the reordering is performed is to set an optimal predicted seek time.

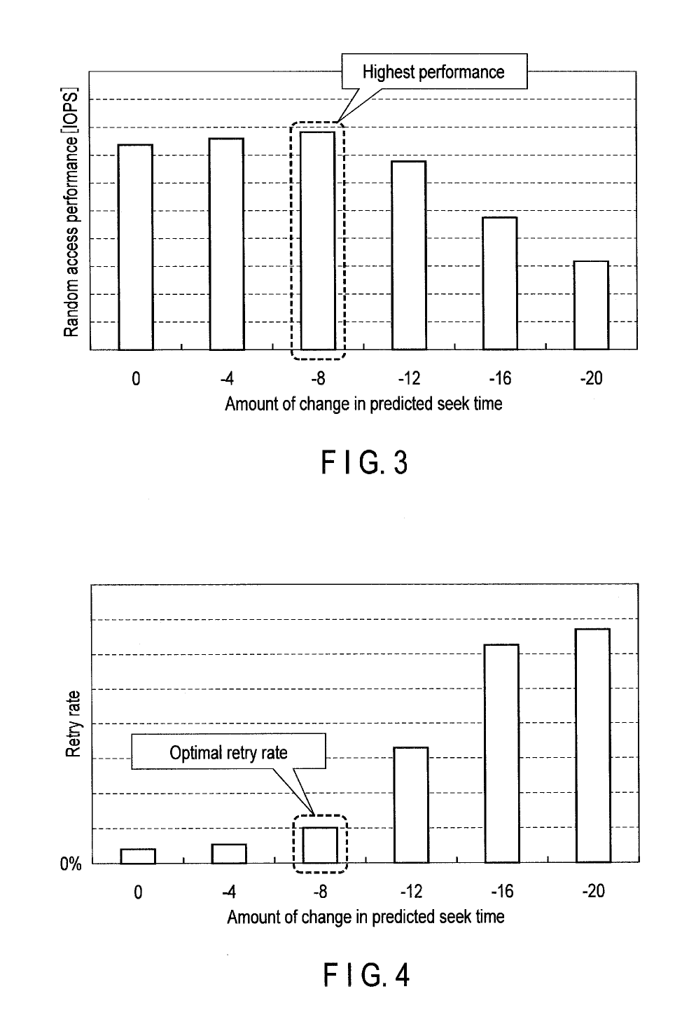

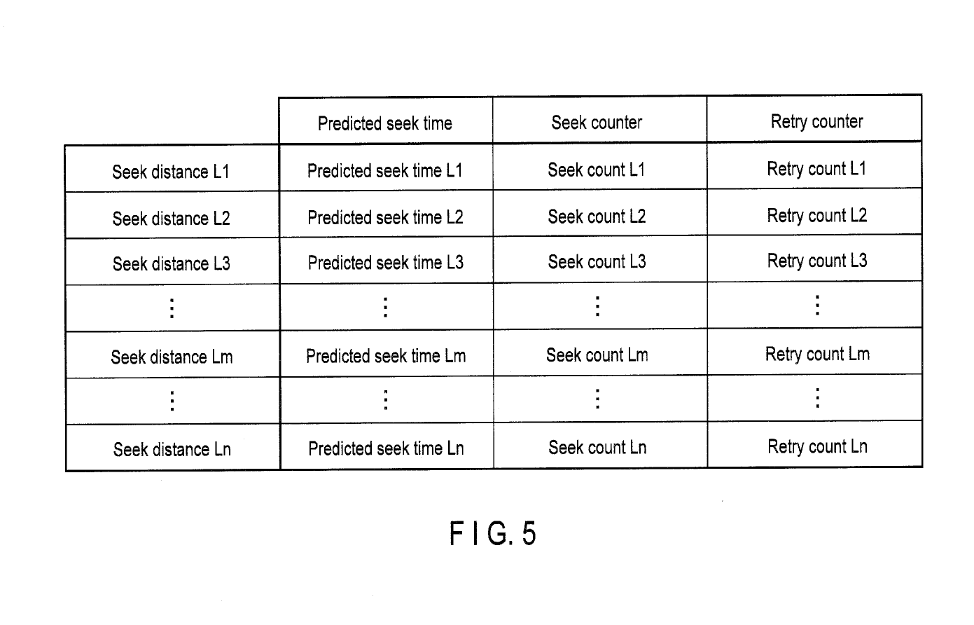

FIG. 3 illustrates an example of relationship between an amount of change in a predicted seek time and random access performance. In the example of FIG. 3, the highest performance is achieved when the amount of change in the predicted seek time is −8. FIG. 4 illustrates an example of relationship between the amount of change in a predicted seek time and a retry rate. In relationship between the random access performance and the retry rate of an HDD, there are some cases where the device achieves a better performance with a retry rate of a certain degree such as zero or more rather than having the retry rate of zero. This is because, when a predicted seek time contains an allowance sufficient to make the retry rate zero, unnecessary rotational latency occurs and thus the number of commands processed per hour is reduced. Here, FIG. 4 shows that the optimal retry rate is the retry rate of a case where the amount of change in the predicted seek time is −8 and the highest performance is achieved in FIG. 3. That is, FIG. 4 shows that the retry rate in a case where the amount of change in the predicted seek time is −8 is the above-described retry rate of a certain degree such as zero or more, namely, the optimal retry rate. In other words, the highest random access performance can be achieved by setting the optimal retry rate. Further, the time which produces the optimal retry rate will be the optimal predicted seek time. Therefore, in order to achieve the optimal seek characteristics (to achieve the highest random access performance), it is desirable that the optimal predicted seek time be set.

However, as described above, the seek characteristics are not necessarily constant, but vary because of individual differences between devices and an environment. That is, the seek characteristics vary from a magnetic disk device to another and also vary with the operating environment. Therefore, if it is possible to change the relationship between a seek distance and a predicted seek time based on the device or the operating environment instead of fixing it, the optimal seek characteristics can be achieved constantly.

In the present embodiment, a retry rate is acquired by the retry rate acquisition unit 80a for each seek distance, and a predicted seek time is adjusted by the predicted seek time adjustment unit 80b based on the acquired retry rate. More specifically, a retry rate is compared with a reference retry rate (optimal retry rate), and based on the comparison result, a predicted seek time is adjusted. More specifically, a reference retry rate is determined according to a seek distance, and a predicted seek time is extended when a retry rate is higher than the reference retry rate while the predicted seek time is reduced when the retry rate is lower than the reference retry rate. In this way, a seek operation can constantly be performed at the optimal seek time for a seek distance, and thus it becomes possible to improve the characteristics of the seek operation.

FIG. 5 is a schematic view of a table showing the relationship between a seek distance and a predicted seek time.

The table of FIG. 5 is set in the memory 84 of FIG. 1. This table is used at the time of command reordering in queuing processing.

As shown in FIG. 5, the relationships between a plurality of seek distances and a plurality of predicted seek times are set in the table. That is, a predicted seek time is set for each seek distance. Further, a seek counter and a retry counter are set for each seek distance, and the number of seeks and the number of retries are counted for each seek distance. When a seek operation is performed at a certain seek distance, that is, when a read operation or a write operation is performed at a certain seek distance, a seek counter set to a certain distance is incremented. Further, when a retry occurs at a certain distance, a retry counter set to the distance is incremented.

That is, the number of retries is determined on the basis of the retry counter, and the number of seeks is determined on the basis of the seek counter. Then, the ratio of the retry count to the seek count is calculated, giving the retry rate. The retry rate is calculated when the number of seeks reaches a particular value.

Next, the operation in the present embodiment will be described. Note that the operation in the present embodiment is mainly executed by the controller 80 provided in the magnetic disk device as shown in FIG. 1.

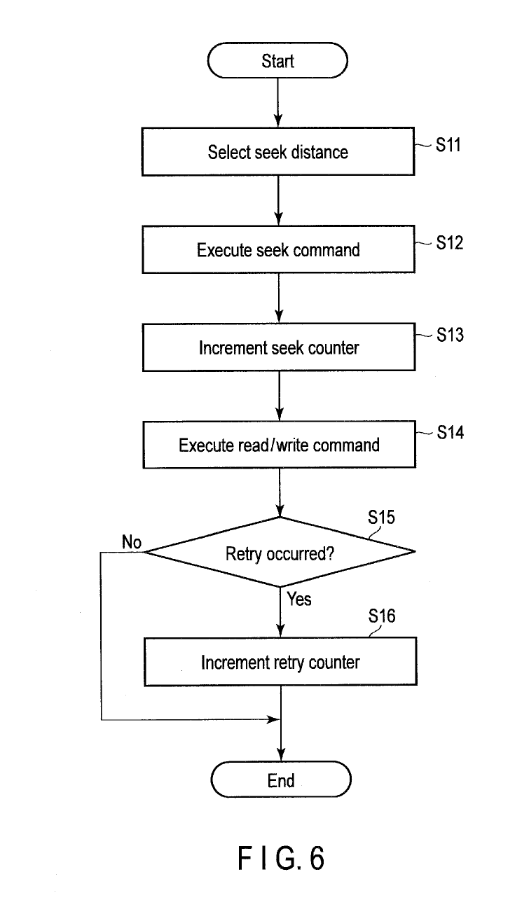

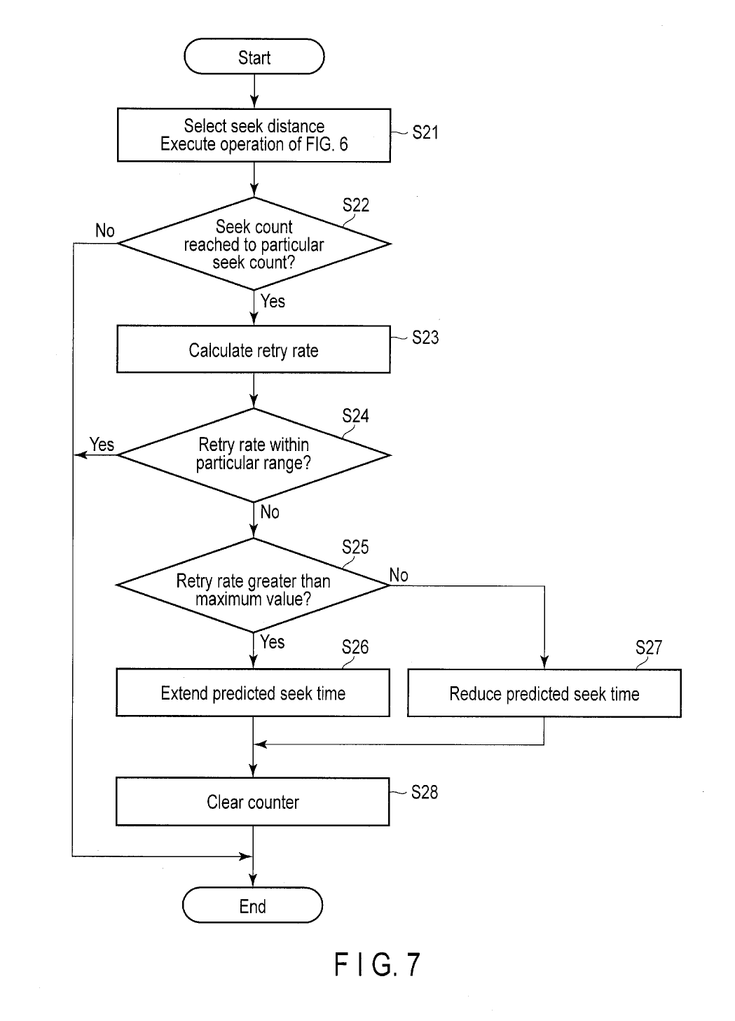

FIG. 6 is a flowchart showing the operation related to a seek counter and a retry counter.

Firstly, for example, a seek distance is selected by the command reordering of the queuing processing (S11). Then, a seek command is executed at the selected seek distance (S12). When the seek command is executed, the seek counter is incremented by 1 (S13). Subsequently, a read command or a write command is executed (S14).

Next, it is determined whether a retry occurs or not when a read command or a write command is executed (S15). If a retry has occurred, the retry counter is incremented by 1 (S16). If no retry has occurred, the retry counter remains unchanged.

FIG. 7 is a flowchart showing a method of adjusting a predicted seek time.

Firstly, for example, a seek distance is selected by the command reordering of the queuing processing, and the operation shown in the flowchart of FIG. 6 is executed (S21).

Next, it is determined whether the seek counter at the selected seek distance has reached a particular value or not (S22). That is, it is determined whether the number of seeks has reached a particular value or not.

If the seek counter has reached the particular value (Yes in S22), the retry rate is calculated (S23). That is, the ratio of the retry count to the seek count is calculated, giving the retry rate. Then, it is determined whether the calculated retry rate is within a particular range or not (S24). That is, it is determined whether or not the retry rate at the selected seek distance is within the range of a reference retry rate determined according to the seek distance. If the seek count has not reached the particular value (No in S22), the operation shown in the flowchart of FIG. 7 ends.

If the retry rate is not within the range of the reference retry rate (No in S24), it is determined whether the retry rate is greater than the maximum value of the reference retry rate or not (S25). If the retry rate is within the range of the reference retry rate (Yes in S24), on the other hand, the operation shown in the flowchart of FIG. 7 ends.

If the retry rate is greater than the maximum value of the reference retry rate (Yes in S25), the predicted seek time is extended (S26). If the retry rate is not greater than the maximum value of the reference retry rate (No in S25), that is, if the retry rate is less than the minimum value of the reference retry rate, the predicted seek time is reduced (S27). Note that the extension and reduction of the predicted seek time is performed in steps of a particular adjustment time (S27). For example, the predicted seek time is extended or reduced in units of a particular number of servo samples. Further, it is possible to increase the size of the adjustment time step of a predicted seek time to perform rough adjustment, and to reduce the size of the adjustment time step to perform fine adjustment.

After the processing of S26 or S27, that is, after the predicted seek time is changed, the seek counter and the retry counter are cleared (S28). That is, the seek counter and the retry counter are reset to zero.

As described above, in the present embodiment, a retry rate is acquired for each seek distance, and based on the acquired retry rate, a predicted seek time is adjusted. More specifically, the retry rate is compared with a reference retry rate (optimal retry rate), and based on the comparison result, a predicted seek time is adjusted. In this way, it becomes possible to constantly perform a seek operation at the optimal predicted seek time for each seek distance, and thus the characteristics of the seek operation can be improved.

Note that, in the above-described embodiment, a retry rate is acquired when the number of seeks reaches a particular value, but it is also possible to acquire a retry rate when the total time spent on a particular operation of the magnetic disk device reaches a particular number of hours. For example, a retry rate may be acquired when the total time for which the magnetic disk is accessed reaches a particular number of hours.

Further, in the above-described embodiment, the retry rate is calculated only for a selected seek distance, and the predicted seek time is adjusted only for the selected seek distance. However, it is also possible to calculate retry rates and adjust predicted seek times for two or more seek distances including a selected seek distance.

Still further, it is possible to perform the above-described adjustment of the predicted seek time by adjusting the device in an online adjustment process in a test process. In that case, online adjustment can be performed by acquiring a reference retry rate by means of a test program and using a specific random access pattern. Still further, it is also possible to perform the above-described adjustment of a predicted seek time by the user adjusting the device offline. In that case, offline adjustment can be performed by using a reference retry rate set in firmware (FW).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of controlling a magnetic disk device, comprising:
acquiring a retry rate indicating a ratio of the number of retries to the number of seeks for a seek distance selected in a seek operation related to a read operation and a write operation; and
adjusting a predicted seek time for the selected seek distance based on the acquired retry rate.

2. The method of claim 1, wherein a relationship between the selected seek distance and a predicted seek time for the selected seek distance is set as relationships between a plurality of seek distances and a plurality of predicted seek times.

3. The method of claim 2, wherein the set relationships between the plurality of seek distances and the plurality of predicted seek times are used at a time of command reordering in queuing processing.

4. The method of claim 1, wherein the number of retries and the number of seeks are counted for a seek distance.

5. The method of claim 1, wherein the number of retries and the number of seeks are reset after the predicted seek time is adjusted.

6. The method of claim 1, wherein the predicted seek time is adjusted based on a comparison result acquired with comparing the retry rate with a reference retry rate.

7. The method of claim 6, wherein the predicted seek time is extended when the retry rate is greater than the reference retry rate, and the predicted seek time is reduced when the retry rate is less than the reference retry rate.

8. The method of claim 6, wherein the reference retry rate is determined according to a seek distance.

9. The method of claim 1, wherein the retry rate is acquired when the number of seeks reaches a particular value.

10. The method of claim 1, wherein the retry rate is acquired when a total number of hours spent on a particular operation of the magnetic disk device reaches a particular value.

11. A magnetic disk device comprising;
a magnetic disk;
a magnetic head for performing a read operation and a write operation on the magnetic disk; and
a controller configured to control the read operation and the write operation, wherein
the controller acquires a retry rate indicating a ratio of the number of retries to the number of seeks for a seek distance selected in a seek operation related to the read operation and the write operation, and
the controller adjusts a predicted seek time for the selected seek distance based on the acquired retry rate.

12. The device of claim 11, wherein a relationship between the selected seek distance and a predicted seek time for the selected seek distance is set as relationships between a plurality of seek distances and a plurality of predicted seek times.

13. The device of claim 12, wherein the set relationships between the plurality of seek distances and the plurality of predicted seek times are used at a time of command reordering in queuing processing.

14. The device of claim 11, wherein the number of retries and the number of seeks are counted for a seek distance.

15. The device of claim 11, wherein the number of retries and the number of seeks are reset after the predicted seek time is adjusted.

16. The device of claim 11, wherein the predicted seek time is adjusted based on a comparison result acquired with comparing the retry rate with a reference retry rate.

17. The device of claim 16, wherein the predicted seek time is extended when the retry rate is greater than the reference retry rate, and the predicted seek time is reduced when the retry rate is less than the reference retry rate.

18. The device of claim 16, wherein the reference retry rate is determined according to a seek distance.

19. The device of claim 11, wherein the retry rate is acquired when the number of seeks reaches a particular value.

20. The device of claim 11, wherein the retry rate is acquired when a total number of hours spent on a particular operation of the magnetic disk device reaches a particular value.
